(19) United States
(12) Patent Application Publication
(10) Pub. No.: US 2018/0302948 A1
(43) Pub. Date: Oct. 18, 2018

(54) ROTATABLE PUSH-TO-TALK (PTT) BUTTON FOR TALKGROUP SELECTION AND PTT COMMUNICATION INITIATION

(71) Applicant: MOTOROLA SOLUTIONS, INC., Chicago, IL (US)

(72) Inventor: Yury Vladimirovich Kotlyarov, Saint-Petersburg (RU)

(73) Assignee: Motorola Solutions, Inc., Chicago, IL (US)

(21) Appl. No.: 15/737,888

(22) PCT Filed: Sep. 17, 2015
(86) PCT No.: PCT/RU2015/000590

§ 371 Date: Dec. 19, 2017

(51) Int. Cl. H04W 76/45; H04W 4/10; H04M 1/23

(52) U.S. Cl. CPC H04W 76/45; H04M 1/23; H04W 4/10

(57) ABSTRACT

A push-to-talk (PTT)-enabled communication device with an interface for selecting a talkgroup and initiating a PTT communication with the talkgroup is disclosed. The interface includes a component configured to (1) select the talkgroup in response to the component receiving a first input that causes a rotation of the component, and (2) initiate the PTT communication with the talkgroup in response to the component receiving a second input that is different from the first input. In one example, the interface may comprise a physical PTT button that is rotatable. In another example, the interface may comprise an apparatus with a graphical user interface (GUI) including a PTT-button area that visually rotates.

### BACKGROUND OF THE INVENTION

Push-to-Talk (PTT), or Push-to-Transmit, generally refers to a communication method in which signal transmission and reception occurs in a half-duplex mode. The PTT method is usually associated with a two-way radio (sometimes also referred to as a “walkie-talkie”) that is equipped with a so-called PTT button that allows a user to switch between transmit and receive modes. For example, if a user wishes to transmit a voice signal to one or more other users, the user will press the PTT button and start talking into a microphone. On the other hand, to terminate the transmission, the user will release the PTT button and the radio will return to a receive mode. Two-way radio communication networks include, for example, Land Mobile Radio (LMR) networks that are often used by public safety and other organizations for quick communication and emergency response.

Additionally, modern communication systems also employ a technology known as broadband PTT, or Push-to-Talk over Cellular (PoC) that allows users to use a traditional full-duplex mobile/cellular telephone (e.g., a smart telephone) in a similar way as a two-way radio. A user device may be configured with a suitable PTT application program (e.g., a PTT client application) to provide the user device with a PTT capability.

Typical PTT devices allow a user to make a group call in which the user may send a transmission to a group of users who are members of a given talkgroup. In this regard, the user may select a particular talkgroup and then press a PTT button to start communicating with the talkgroup. Unfortunately, traditional ways of selecting a talkgroup and initiating a communication with that talkgroup may be slow and inconvenient.

As an example, one common way to select a talkgroup is to use a list. To select a desired talkgroup, a user may have to first use means such as joysticks, “up/down” buttons, or dedicated scroll buttons to scroll through a list of available talkgroups, and then press a separate PTT button to initiate communication with the talkgroup. In some software-based user interfaces, a talkgroup selection list may also be outside of a display screen having a soft button functioning as a PTT button.

Accordingly, there is a need for a PTT button for talkgroup selection and PTT communication initiation.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a two-way radio configured in accordance with one prior art method;

FIG. 2 illustrates a PTT-enabled communication device arranged in accordance with some embodiments;

FIG. 3 illustrates an example of a communication device including a physical PTT button, in accordance with some embodiments;

FIG. 4 illustrates a side view of the communication device of FIG. 3;

FIG. 5 illustrates conceptually the physical PTT button of FIG. 3, in accordance with some embodiments;

FIG. 6 illustrates one implementation of the physical PTT button of FIG. 3, in accordance with some embodiments;

FIG. 7 illustrates another implementation of the physical PTT button of FIG. 3, in accordance with some embodiments;

FIG. 8 illustrates an example of a communication device having a software-based PTT-button area, in accordance with some embodiments; and

FIG. 9 illustrates the PTT-button area of FIG. 6, in accordance with some alternative embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In accordance with one aspect, a communication device having a push-to-talk (PTT) capability is disclosed. The communication device comprises an interface configured to select a talkgroup and initiate a PTT communication with the talkgroup. The interface includes a component configured to (i) select the talkgroup in response to the component receiving a first input that causes a rotation of the component, and (ii) initiate the PTT communication with the talkgroup in response to the component receiving a second input that is different from the first input.

In some embodiments, the interface may comprise a physical PTT button that includes a component that is rotatable and pressable. Further, the component is configured to (i) select a talkgroup responsive to the component being rotated, and (ii) initiate a PTT communication with the talkgroup responsive to the component being pressed.

In some other embodiments, the interface may comprise an apparatus including (i) a display device having a display area and (ii) a processor coupled with the display device and configured to execute program instructions to cause the display device to provide a graphical user interface (GUI) including a PTT-button area. The PTT-button area occupies a portion of the display area. The PTT-button area is configured to select a talkgroup in response to the PTT-button area receiving a first input, and the display device is configured to display a rotation of the PTT-button area in response to the PTT-button area receiving the first input. Further, the PTT-button area is configured to initiate a PTT communication with the talkgroup in response to the PTT-button area receiving a second input that is different from the first input.

As noted previously herein, traditional ways of selecting a talkgroup and initiating a communication with the selected talkgroup may be slow and inconvenient.

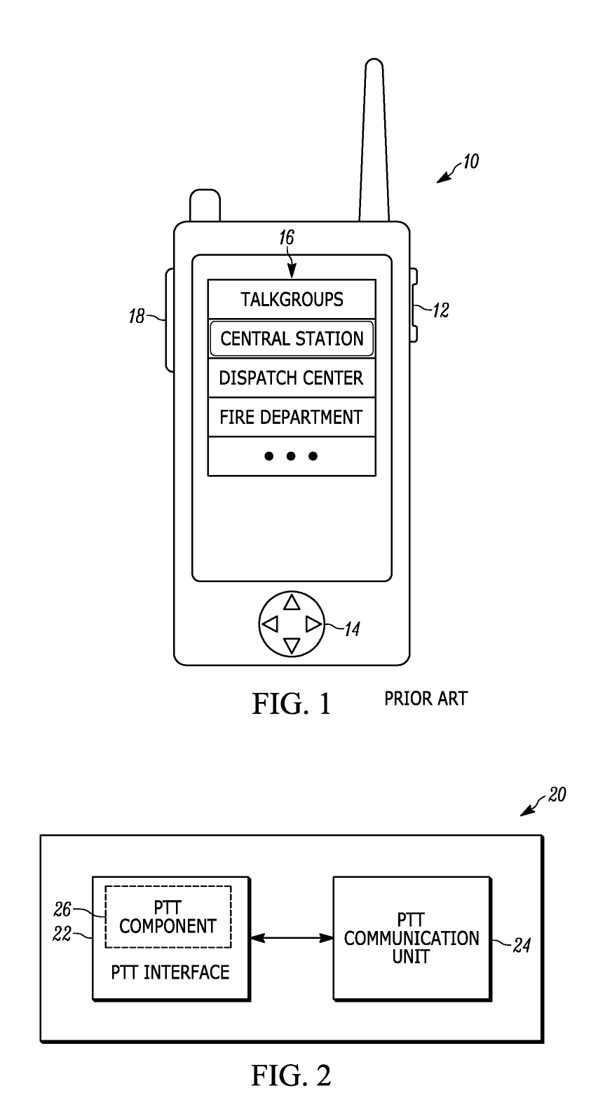

FIG. 1 illustrates one prior art two-way radio 10 in which a user interface includes “up/down” buttons 12 and scroll buttons 14 that may be used for selecting a desired talkgroup from a talkgroup list 16, such as by scrolling through the list 16 until a desired talkgroup is highlighted (e.g., a “Central Station,” as in FIG. 1). The radio 10 further has a separate PTT button 18 for initiating, e.g., a PTT call with the desired talkgroup. Hence, with the two-way radio 10, a user may have to push the “up/down” buttons 12 or the scroll buttons 14 multiple times before being able to start talking with the desired talkgroup by pressing the PTT button 18. This may be undesirable in emergency situations or other mission-critical applications.

Further, in certain situations, it may be desirable to send a PTT call alert (e.g., an audible tone) indicating to a receiving party that another party wants to engage in a PTT call. Traditionally, transmitting a call alert may require selecting the receiving party from a list of contacts, pressing a dedicated “alert” button (e.g., a soft button), and, for example, subsequently pressing and releasing a PTT button to send the call alert. Such method of selecting a recipient of a PTT call alert and initiating the PTT call alert is also not particularly fast or convenient.

The present disclosure provides a more convenient mechanism to facilitate selecting a talkgroup and initiating a PTT communication with the talkgroup.

FIG. 2 illustrates a PTT-enabled communication device 20 arranged in accordance with some embodiments. As shown in FIG. 2, the PTT-enabled communication device 20 comprises a PTT interface 22 coupled to a PTT communication unit 24. It will be appreciated that the PTT-enabled communication device 20 may include additional components not shown for simplicity purposes.

In accordance with some embodiments, the PTT-enabled communication device 20 may be any kind of suitable communication device (e.g., a handheld or portable device) having a PTT capability. Some examples of such PTT-enabled communication device 20 include a digital or analog two-way radio (e.g., an LMR device), a mobile telephone configured with a PTT application program, and a communication device that functions as a two-way radio and a mobile telephone.

Further, in illustrative embodiments, the PTT interface 22 is used to select a talkgroup and initiate a PTT communication with the talkgroup. More particularly, the PTT interface 22 includes a PTT component 26 that is used for both a selection of a talkgroup and an initiation of the PTT communication with that talkgroup.

Namely, the PTT component 26 is configured to (1) select the talkgroup in response to the PTT component 26 receiving a first input that causes a rotation of the PTT component 26, and (2) initiate the PTT communication with the talkgroup in response to the PTT component 26 receiving a second input that is different from the first input. In addition, in some embodiments, a duration of the second input may provide at least in part the basis for recognizing which type of the PTT communication is to be initiated. More specifically, the PTT component 26 is configured to (i) initiate the PTT call alert when the duration of the second input is less than a predetermined period of time, and (ii) initiate the PTT call when the duration of the second input is at least the predetermined period of time.

In accordance with the illustrative embodiments, the input is received when the PTT component 26 is physically operated (e.g., by a user and/or other entity), in one or more given manners. As some examples, the input may include rotating of the PTT component 26, pressing of the PTT component 26, operating of the PTT component 26 using touchscreen-based methods (e.g., single or multiple touches/gestures), and/or the like.

The PTT communication unit 24 may be arranged accordingly for assisting in selection of and PTT communications with desired talkgroup(s). Although not shown explicitly in FIG. 2, the PTT communication unit 24 may include various radio frequency (RF) circuitry, such as transmitter/receiver (or transceiver) circuitry, operable on one or more transmit/receive frequencies for transmission and reception of signals (e.g., voice or other type of audio signals). The PTT communication unit 24 may further include control element(s) for controlling the RF circuitry, data storage for holding indications of selectable talkgroups, control element(s) cooperating with the PTT interface 22 in controlling a selection of a talkgroup, a microphone for receiving voice/audio signals to be transmitted by the PTT communication unit 24, an antenna for emitting/receiving radio signals, and the like.

It should, however, be understood that the PTT interface 22 may include various other elements not shown in FIG. 2.

Further, as used herein, the term “talkgroup” broadly refers to a group of users to whom a PTT-related transmission may be simultaneously sent or broadcasted to, virtual channel(s) (e.g., as in trunked radio systems, for instance), physical channel(s) (e.g., a group of radio characteristics, such as particular transmit/receive frequency pair(s)), chat(s), zone(s) (e.g., a group of channels), or any combination of the aforementioned, such as for example, a combination of a zone and a channel. Additionally, it is conceivable that, in some instances, a talkgroup may include only a single user.

In addition, the term “PTT communication” generally refers to a transmission of a signal (e.g., a voice/audio signal or other type of signal) related to the PTT method, where such transmission may or may not be subsequently followed by a reception of one or more response signals. For example, the PTT communication may be a PTT call alert or a PTT call. In this regard, the term “PTT call” generally refers herein to a transmission of signal(s) that occurs over a PTT connection. On the other hand, the term “PTT call alert” generally refers herein to a transmission of suitable signal(s) to one or more recipients indicative of a sender's desire to engage in a PTT call with those recipient(s).

In operation, to initiate a PTT communication with a given talkgroup, such talkgroup may be selected from multiple talkgroups available for selection on the PTT-enabled communication device 20. As discussed hereinbefore, in some prior art methods, such selection may be accomplished, e.g., by using “up/down buttons” on a user interface to select a talkgroup from a list of talkgroups. However, such methods may be slow and inconvenient, especially in mission-critical situations. Additionally, a separate PTT button (e.g., a hardware or software-based PTT button) may have to be pressed to initiate a PTT communication with the selected talkgroup.

In contrast, in accordance with some embodiments, a selection of a talkgroup and an initiation of a PTT communication with the talkgroup both occur via an operation of the same PTT component 26. Namely, the selection of the talkgroup occurs in response to the PTT component 26 receiving a first input that causes a rotation of the PTT component 26 (e.g., at least a visible rotation), while the initiation of the PTT communication with the talkgroup selected via the first input occurs in response to the PTT component 26 receiving a second, different, input.

To illustrate, the PTT interface 22 may take the form of a physical PTT button including a component that is capable of being rotated and pressed (or pushed). In such case, a desired talkgroup may be selected by rotating the component, while a PTT communication with the talkgroup may be then initiated by pressing the same component. In addition, based on a duration of pressing of the component, either a PTT call alert or a PTT call may be initiated. For instance, if the component is pressed for less than a predetermined period of time, the PTT call alert is initiated. On the other hand, if the component is pressed for at least the predetermined period of time, the PTT call is initiated.

Advantageously, the PTT component 26 of the PTT interface 22 may operate in multiple modes related to multiple functions including talkgroup selection and PTT communication initiation. Additionally, selecting a talkgroup by means of rotation of the PTT component 26 may be faster and more convenient than other typical methods of talkgroup selection, such as scrolling through a list via the use of physical or soft buttons, multiple touch-based scrolls, etc. A faster mechanism to select a talkgroup may be particularly beneficial in public safety applications where PTT-enabled communication devices are often used in emergency situations to provide quick communication between users. Also, a selection of a given PTT communication type, such as a PTT call alert, may be simplified by eliminating a need for using additional dedicated buttons (e.g., a soft “alert” button).

In one example, the rotation may be a physical rotation about an axis, such as in the case of the PTT component 26 being a rotatable component included in a physical PTT button. In another example, the rotation may be a visual rotation about an axis, such as in the case of the PTT component 26 being a part of a GUI for, e.g., a touchscreen display device.

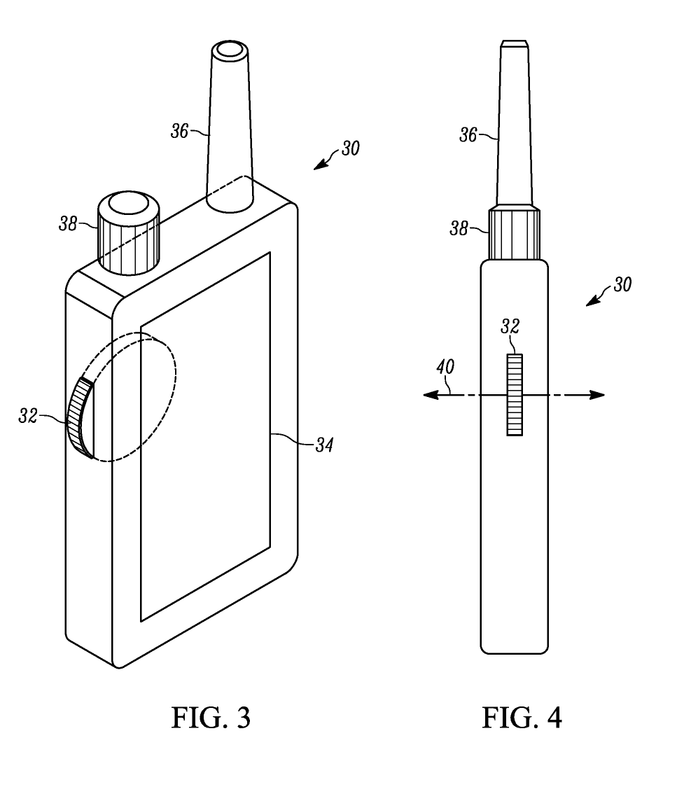

FIG. 3 illustrates an example of a communication device 30 including a physical PTT button 32, in accordance with some embodiments. As shown in FIG. 3, the communication device 30 further includes a display 34, an antenna 36 for communicating radio signals, and one or more auxiliary controls 38. FIG. 4 illustrates a side view of the communication device 30.

The communication device 30 may be any communication device with a PTT capability. It will be appreciated that the communication device 30 may be an LMR device including an analog or digital two-way radio. In other embodiments, the communication device 30 may be a device having a dual functionality of a two-way radio and a mobile telephone. Some examples of the communication device 30 include the ASTRO®, TETRA®, and MOTOTRBO® radio devices available from Motorola Solutions Inc.

In accordance with some embodiments, the display 34 may, for example, display a list of talkgroups available for selection and a selected talkgroup (e.g., a selected channel number or a name of a given talkgroup). However, the display 34 may also display other functions and settings of the communication device 30.

The one or more auxiliary controls 38 may include a volume control, as well as any other controls used in operating the communication device 30. It will be appreciated that although one auxiliary control is illustrated in FIG. 3, the communication device 30 may incorporate any number of auxiliary controls. As an example, the communication device 30 may be equipped with additional or optional mechanisms, such as rotary knobs and/or switches, used for channel and/or zone selection to make individual or group PTT calls. For instance, in some existing two-way radios, a selection of a desired talkgroup occurs by means of switching to a given zone (e.g., by using a switch control) and then selecting a particular channel (e.g., by turning a rotary channel-selection knob) within that given zone. Once selected, pressing a dedicated PTT button causes a voice communication to be transmitted on the selected zone channel.

Although not shown in FIG. 3, it should be understood that the communication device 30 may include other elements, such as a microphone for receiving voice/audio signals, a menu button for changing functions and settings, menu select buttons, a keypad, a speaker for transmitting audible signals, and the like.

In accordance with some embodiments, the PTT button 32 comprises a component for selecting a talkgroup and initiating a PTT communication with the talkgroup. More specifically, the component is rotatable and pressable, and configured to (i) select the talkgroup responsive to the component being rotated, and (ii) initiate the PTT communication responsive to the component being pressed.

In particular, in order to select a given talkgroup for a PTT communication, the PTT button 32 is rotated until the given talkgroup is selected. In some embodiments, the communication device 30 may be configured (e.g., programmed and equipped with suitable software/hardware) to provide multiple talkgroups that are available for selection. As the PTT button 32 is rotated, an indication of which talkgroup is currently selected may be shown on the display 34. In this regard, a selection of a particular talkgroup may correspond to a current position of the PTT button 32. For instance, the PTT button 32 may be configured to select a first talkgroup when the PTT button 32 rotates to a first position and to select a second talkgroup when the PTT button 32 rotates to a second position different from the first position.

Once the communication device 30 provides an indication that a desired talkgroup is selected, the PTT button 32 may be pressed to initiate a PTT communication with the desired talkgroup. In some embodiments, following the rotation, the PTT button 32 may be released and then pressed to initiate the PTT communication with the desired talkgroup. Alternatively, the PTT button 32 may be rotated to select the desired talkgroup, and subsequently pressed, without releasing it, to initiate the PTT communication with the desired talkgroup.

Further, in accordance with some embodiments, the PTT button 32 may be configured such that a period of time for which the PTT button 32 is in a pressed state may be indicative of whether the PTT communication to be initiated is a PTT call alert or a PTT call. More specifically, to initiate a PTT call alert, the PTT button 32 is pressed for less than a predetermined period of time. To initiate a PTT call, the PTT button 32 is pressed for at least the predetermined period of time.

For instance, to initiate a PTT call alert, the PTT button 32 may be pressed for less than a predetermined number of seconds. On the other hand, to initiate a PTT call, the PTT button 32 may be pressed for at least the predetermined number of seconds. For example, during a PTT call, the PTT button 32 will be continuously pressed while a signal is provided for transmission (e.g., while a user speaks to a microphone). Further, in some embodiments, the communication device 30 may be configured to provide, e.g., a visual and/or audio response (e.g., play an audible tone) indicating that the PTT call alert has been initiated.

As shown in FIG. 3, the PTT button 32 may be located on a side of the communication device 30 to facilitate user operation of the button 32 as a user holds the device 30. As further shown in more detail in FIG. 4, in some embodiments, the PTT button 32 is positioned such that it rotates about an axis 40 parallel to the side of the communication device 30. However, in alternative embodiments, the PTT button 32 may be positioned such that it rotates about an axis perpendicular to the side of the communication device 30. Also, in other embodiments, instead of being located on the side of the communication device 30 as shown in FIG. 3, the PTT button 32 may be located in a different part of the communication device 30 (e.g., on the front of the communication device 30).

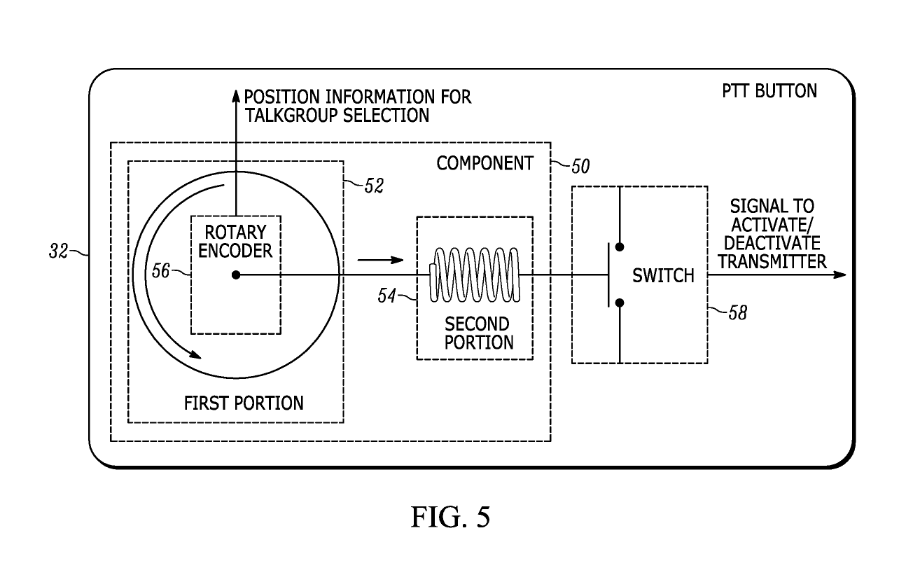

FIG. 5 illustrates conceptually the PTT button 32 according to some embodiments. As shown in FIG. 5, the PTT button 32 comprises a component 50. The component 50 includes a first portion 52 and a second portion 54. In general, the first portion 52 provides capability for the component 50 to rotate about a first axis (e.g., the axis 40 shown in FIG. 4) and the second portion 54 provides capability for the component 50 to be pressed along a second axis (e.g., an axis perpendicular to the first axis).

In practice, as shown in FIG. 5, the component 50 may include a rotary encoder 56, such as a part of the first portion 52. As known to those skilled in the art, a rotary encoder is a device that converts an angular position or motion of a shaft or axle to an analog or digital code/signal. As such, digital encoders, for instance, may produce a unique digital code for each distinct angular position (e.g., an angle of the shaft).

Accordingly, in some embodiments, the rotary encoder 56 may be a digital rotary encoder configured such that each discrete angular position corresponds to a respective talkgroup. For example, as illustrated in FIG. 5, current position information (e.g., a signal representative of a particular digital code) may be sent to a controller (not shown) programmed to generate, based on the position information, suitable control signal(s) for tuning a transmitter for transmission associated with a particular talkgroup. The controller may be, e.g., one or more processors, such as general purpose processors and/or dedicated processors (e.g., application specific integrated circuits (ASICs)) or digital signal processors (DSPs)).

Hence, as the PTT button 32 rotates, a particular talkgroup may be selected based on a current position of the rotary encoder 56. As noted previously herein in connection with FIG. 3, as the PTT button 32 rotates, an indication of which talkgroup is currently selected may be shown on the display 34. Alternatively, if the communication device 30 is not equipped with the display 34, an indication of current talkgroup selection may be provided via suitable audible means, visual means, haptic means, and/or the like. Further, when the PTT button 32 is rotated to a position corresponding to a desired talkgroup, the PTT button 32 may be, for example, released and then pressed to initiate a PTT communication with the selected talkgroup.

Further, in some embodiments, the current talkgroup selection is maintained until the PTT button 32 is subsequently rotated to select another talkgroup from available talkgroups. For instance, the talkgroup selection may be maintained by leaving the PTT button 32 in its current position. Accordingly, the PTT communication may be initiated with the currently selected talkgroup multiple times (e.g., by pressing and then releasing the PTT button 32, as in a typical PTT interaction) until another talkgroup is selected.

As shown in FIG. 5, an operation of pressing and releasing the PTT button 32 from a pressed state may be accomplished via the second portion 54 of the component 50. As shown, the second portion 54 may include a spring-based mechanism that provides capability for the component 50 to be pressed and released from the pressed state. As such, when the component 50 is pressed, it may move from a first position to a second position with respect to the communication device 30. Further, when the component 50 is released from the pressed state, the component 50 may return from the second position to the first position.

In particular, as shown in FIG. 5, the component 50 being pressed and released from the pressed state may function to close and open a switch 58. In a typical PTT operation, when a PTT button is pressed, a radio transceiver in the communication device 30 may be switched to a transmit mode. For example, when making a PTT call, closing of a PTT switch causes an antenna to be coupled with a transmitter, while a voice/audio signal from a microphone is applied to the transmitter for modulation of an RF transmit signal. Accordingly, when the component 50 is pressed and released from the pressed state, the switch 58 may be selectively closed and opened to activate and deactivate the transmitter, respectively.

In addition, as noted previously herein, a period of time for which the PTT button 32 is in a pressed state may be indicative of whether the PTT communication to be initiated is a PTT call alert or a PTT call. In this regard, in some embodiments, the PTT button 32 may be configured to initiate a PTT call alert or a PTT call based on a duration of closing of the switch 58. In this regard, although not explicitly shown in FIG. 5, the component 50, for example, may include appropriate circuitry to provide a signal (e.g., a voltage signal) indicative of a closed or open state of the switch 58 to a controller (not shown). When such signal indicates that the switch 58 is closed, the controller may be programmed to measure the duration of closing of the switch 58 (e.g., using a digital counter) and generate suitable control signal(s) to cause either a PTT call alert or a PTT call to be initiated.

More specifically, when the switch 58 remains closed for less than a predetermined period of time, the controller may generate suitable control signal(s) to cause a transmitter to start a transmission of signals(s) associated with the PTT call alert (e.g., an audible tone or other signal(s) causing a PTT alert signal on a receiving device). On the other hand, when the switch 58 remains closed for the predetermined period of time or longer, the controller may generate suitable control signal(s) to cause the transmitter to start a transmission of signal(s) associated with the PTT call (e.g., a voice/audio signal provided via a microphone). The controller may be, e.g., one or more processors, such as general purpose processors and/or dedicated processors (e.g., application specific integrated circuits (ASICs)) or digital signal processors (DSPs)).

Note that, although FIG. 5 depicts the first and second portions 52 and 54 as two separate elements, those portions may be included within a single device, such as, e.g., any suitable type of pressable rotary encoder. Further, the switch 58 may be a part of the PTT button 32 or separate from it. Those skilled in the art will appreciate that it might be possible to configure some available rotary encoders to function as switches, such that some pins may be used for rotary encoding while other pins may be used for switching (by, e.g., shortening the pins) when the rotary encoder is pressed.

Additionally, the first portion 52 may include any suitable means that facilitate rotation. For example, in addition to the rotary encoder 56, the first portion 52 may include a rotary element operable with a finger, such as a rotary thumb wheel-like element, that protrudes on the outside of the communication device 30 (as shown in FIGS. 3 and 4) and provides capability for the PTT button 32 to rotate. Such element may be separate from the rotary encoder 56 or the rotary encoder 56 may already include such element.

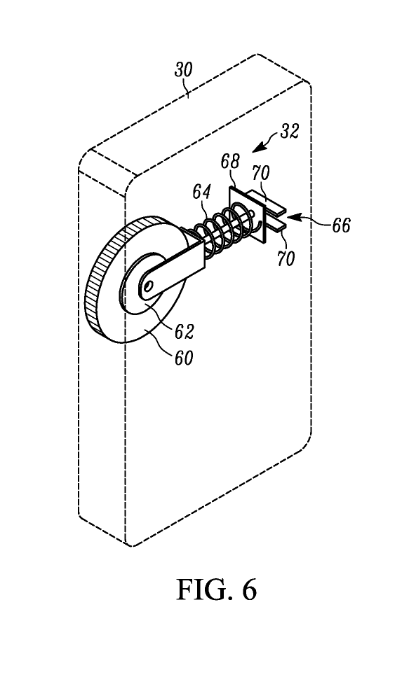

FIG. 6 illustrates one implementation of the PTT button 32, in accordance with some embodiments. As shown in FIG. 6, the PTT button 32 comprises a rotary dial 60, a rotary encoder 62, a spring-loaded rod assembly 64, and a switch 66 including a conductive plate 68 and conductive contacts 70. FIG. 6 depicts an example of the PTT button 32 being at least in part located on a side of the communication device 30 and positioned such that it may rotate about an axis parallel to the side of the communication device 30 (e.g., the axis 40, as in FIG. 4).

In general, the elements shown in FIG. 6 may operate in accordance with the principles described hereinbefore in connection with FIG. 5. To illustrate, a portion of the rotary dial 60 protrudes on the outside of the communication device 30 and facilitates rotation of the PTT button 32, such as by using a thumb. A talkgroup selection may be accomplished via operation of the rotary encoder 62. For instance, as the rotary dial 60 is rotated, an output of the rotary encoder 62 indicative of an encoder position provides, in part, the basis to select a corresponding talkgroup. The rotary dial 60 may be separate from the rotary encoder 62 or the rotary encoder 62 may be configured alternatively to include such dial.

Further, the spring-loaded rod assembly 64 may be coupled to the rotary dial 60 and the rotary encoder 62, and provide capability for the PTT button 32 to be pressed and released from a pressed state. Accordingly, when the rotary dial 60 is pressed, the spring-loaded rod assembly 64 causes a movement from an initial position to another position, such as along an axis perpendicular to the side of the communication device 30. In turn, when the rotary dial 60 is released from the pressed state, the spring-loaded rod assembly 64 causes a return to the initial position.

In addition, the switch 66 may be coupled to the spring-loaded rod assembly 64 such that the switch 66 may be actuated to control a PTT communication (as described in more detail hereinbefore). Specifically, when the PTT button 32 is pressed, the spring-loaded rod assembly 64 causes the conductive plate 68 to come into contact with the conductive contacts 70, thereby closing the switch 66. When released from a pressed state, the spring-loaded rod assembly 64 causes the conductive plate 68 and the conductive contacts 70 to separate, thereby opening the switch 66.

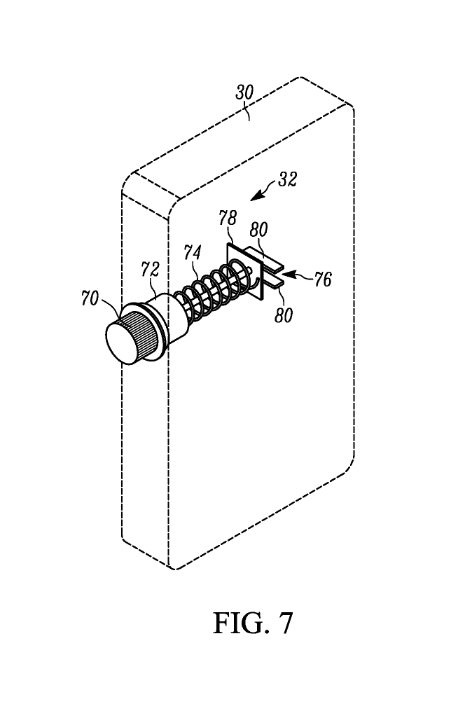

FIG. 7 illustrates another implementation of the PTT button 32, in accordance with one example embodiment. As shown in FIG. 7, the PTT button 32 comprises a rotary knob 70, a rotary encoder 72, a spring-loaded rod assembly 74, and a switch 76 including a conductive plate 78 and conductive contacts 80. FIG. 7 depicts an example of the PTT button 32 being located at least in part on a side of the communication device 30, as in FIG. 6, and positioned such that it may rotate about an axis perpendicular to the side of the communication device 30.

Similar to FIG. 6, the elements shown in FIG. 7 may operate in accordance with the principles described hereinbefore in connection with FIG. 5. To illustrate, the rotary knob 70 is located on the outside of the communication device 30 and facilitates rotation of the PTT button 32. A talkgroup selection may be accomplished via operation of the rotary encoder 72. For instance, as the rotary knob 70 is rotated, an output of the rotary encoder 72 indicative of an encoder position provides, in part, the basis to select a corresponding talkgroup. The rotary knob 70 may be separate from the rotary encoder 72 or the rotary encoder 72 may be configured alternatively to include such knob.

Further, the spring-loaded rod assembly 74 may be coupled to the rotary knob 70 and the rotary encoder 72, and provide capability for the PTT button 32 to be pressed and released from a pressed state. Accordingly, when the rotary knob 70 is pressed, the spring-loaded rod assembly 74 causes a movement from an initial position to another position, such as along the axis perpendicular to the side of the communication device 30. In turn, when the rotary knob 70 is released from the pressed state, the spring-loaded rod assembly 74 causes a return to the initial position.

In addition, the switch 76 may be coupled to the spring-loaded rod assembly 74 such that the switch 76 may be actuated to control a PTT communication (as described in more detail hereinbefore). Specifically, when the PTT button 32 is pressed, the spring-loaded rod assembly 74 causes the conductive plate 78 to come into contact with the conductive contacts 80, thereby closing the switch 76. When released, the spring-loaded rod assembly 74 causes the conductive plate 78 and the conductive contacts 80 to separate, thereby opening the switch 76.

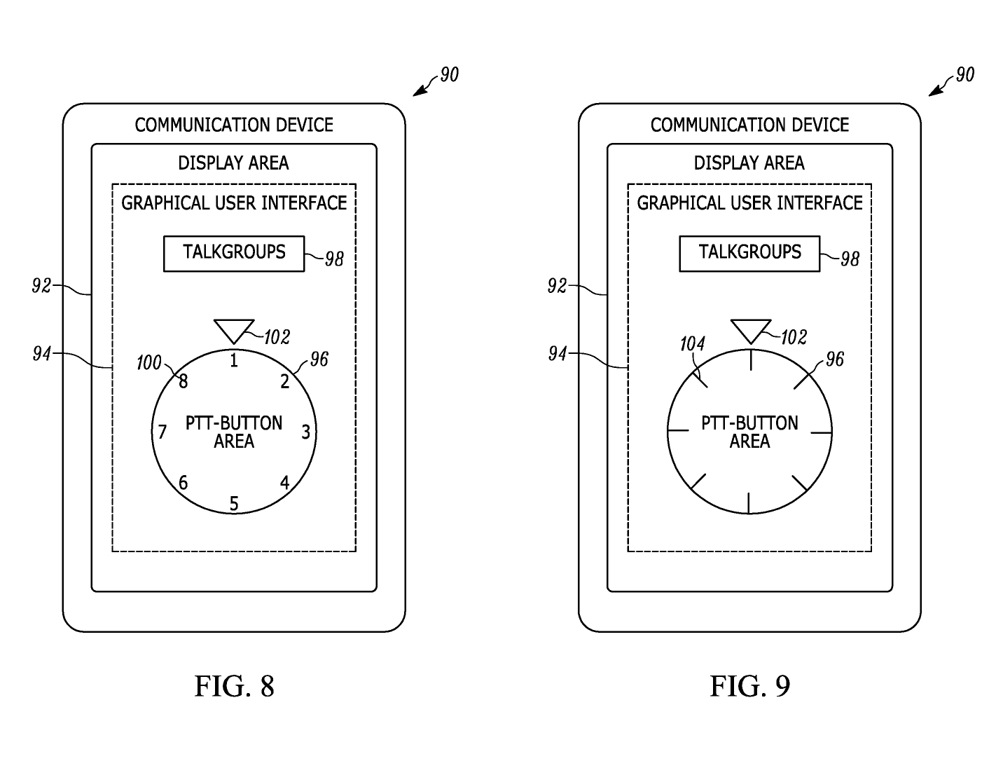

FIG. 8 illustrates an example of a communication device 90 having a software-based PTT-button area, in accordance with some embodiments. As shown in FIG. 8, the communication device 90 includes a display area 92 including a GUI 94. In turn, the GUI 94 includes a PTT-button area 96 and a talkgroup-select area 98.

The communication device 90 is a communication device in which PTT-button functionality may be implemented via suitable software, such as in the case of broadband PTT applications. As one example, the communication device 90 may be a mobile telephone configured with a PTT application program (e.g., the WAVE 3000/5000/7000® client application available from Motorola Solutions Inc.).

The display area 92 may be a part of a display device included in the communication device 90. Although not shown in FIG. 8, the display device may be coupled with a processor embedded in the device 90 and configured to execute program instructions to cause the display device to provide the GUI 94 including the PTT-button area 96. In some embodiments, the display device includes a touch sensitive display, such as a touchscreen, via which the PTT-button area 96 is operated to select a talkgroup and to initiate a PTT communication with the talkgroup.

In accordance with some embodiments, the PTT-button area 96 (as shown in FIG. 8) is a circular area that occupies a portion of the display area 92. Further, the PTT-button area 96 is configured to (i) select a talkgroup in response to the PTT-button area 96 receiving a first input, and (ii) initiate a PTT communication with the talkgroup in response to the PTT-button area 96 receiving a second input that is different from the first input. In this regard, the display device is configured to display a rotation of the PTT-button area 96 in response to the PTT-button area 96 receiving the first input.

In practice, the communication device 90 may be configured (e.g., programmed and equipped with suitable software/hardware) to provide multiple talkgroups that are available for selection. In this regard, the PTT-button area 96 may be configured to select the talkgroup out of the multiple talkgroups in response to the first input received at least in part within the PTT-button area 96, and to initiate the PTT communication in response to the second input received at least in part within the PTT-button area 96. If the display area 92 includes a touch-sensitive display surface, each of the first and second inputs may include a single touch input (e.g., a touch with a single finger or a suitable input device (e.g., a stylus)), a multi-touch input (e.g., a touch using more than one finger), a gesture input (e.g., a multi-touch gesture), etc.

As noted hereinbefore, in some embodiments, the PTT-button area 96 is a circular area. As shown in FIG. 8, the PTT-button area 96 includes a plurality of talkgroup indicators 100 positioned along a circumference of the circular area. In the example shown in FIG. 8, each talkgroup indicator 100 corresponds to one of the talkgroups available for selection on the communication device 90. In particular, in FIG. 8, each of the talkgroup indicators 100 is in the form of a number (e.g., 1-8 as shown), where each number may correspond to a respective talkgroup designated by the number (e.g., “Talkgroup 1,” “Talkgroup 2,” etc.). In addition, the GUI 94 includes another indicator 102 (e.g., in the form of an upside down arrow, as shown) that is positioned outside of the circular area and configured to assist in a selection of one of the talkgroups.

To illustrate, in order to select a given talkgroup for a PTT communication, at least a portion of the PTT-button area 96 (or, more particularly, a physical display surface that covers the display area 92 and corresponds to the PTT-button area 96) may be touched with, e.g., one finger, where the finger is moved in a rotating motion, while continuously maintaining a contact with the display surface. The finger may be wholly within the PTT-button area 96 or at least partially within the PTT-button area 96.

Further, the display device that includes the display area 92 may be configured (e.g., via software) to display the PTT-button area 96 as visually rotating about an axis, such an axis perpendicular to the display surface, in response to sensing a rotational movement of the touch. The PTT-button area 96 may be “rotated” in this manner until one of the talkgroup indicators 100 corresponding to a desired talkgroup is aligned with the indicator 102. Once aligned, the touch may be, for example, removed (i.e., the PTT-button area 96 no longer senses a touch input) to indicate a selection of the desired talkgroup. The talkgroup-select area 98 of the GUI 94 may provide an indication of which talkgroup is currently selected. In another example, once the two indicators 100 and 102 are aligned, the selection of the desired talkgroup may occur after the touch is maintained with the display surface for at least some predefined threshold period of time.

With the benefit of a rotatable PTT-button area, a desired talkgroup may be selected in a single touch, such as by the PTT-button area 96 sensing a continuous touch in a rotating motion as described hereinbefore. This mechanism of talkgroup selection is faster and more convenient than other prior mechanisms, such as, e.g., having to perform multiple swipes to scroll through a talkgroup select list.

Subsequently, to initiate a PTT communication with the selected talkgroup, at least a portion of the PTT button area 96 may receive a second, different, input (e.g., a second, different, touch input). As one example, the PTT-button area 96 may be touched again within an interior portion of the PTT-button area 96. Further, in some embodiments, a duration of the second input may be indicative of whether a PTT call alert or a PTT call is to be initiated.

More specifically, the PTT-button area 96 may be configured to (i) initiate the PTT call alert when the duration of the second input is less than a predetermined period of time, and (ii) initiate the PTT call when the duration of the second input is at least the predetermined period of time. For example, if the second input is a touch input and at least a portion of the PTT-button area 96 senses a touch in a manner indicative of a PTT communication initiation for less than a predetermined period of time, the communication device 90 may be configured to recognize the touch as an initiation of the PTT call alert and responsively start a transmission of signals(s) associated with the PTT call alert (e.g., an audible tone or other signal(s) causing a PTT alert signal on a receiving device). On the other hand, if such touch is maintained for at least the predetermined period of time, the communication device 90 may be configured to recognize the touch as an initiation of the PTT call and responsively start a transmission of signal(s) associated with the PTT call (e.g., a voice/audio signal provided via a microphone).

In other embodiments, talkgroup selection and PTT communication initiation may be accomplished by operating the PTT-button area 96 in other ways than those previously described. As one example, multi-touch gesture recognition may be used to indicate whether the PTT-button area 96 is being “rotated” to select a talkgroup or “pressed” to initiate a PTT communication with the talkgroup. In this regard, multiple, discrete touch zones may not be needed to distinguish between those interactions. Other examples may be possible as well.

Additionally, in some embodiments, the current talkgroup selection is maintained until the PTT-button area 96 again receives an input causing a talkgroup selection (e.g., as described hereinbefore) to select another talkgroup from available talkgroups. For instance, the talkgroup selection may be maintained by sensing that the PTT-button area 96 has been left in its current position (e.g., in a position where the indicators 100 and 102 are aligned as shown in FIG. 8). Accordingly, the PTT communication may be initiated with the currently selected talkgroup multiple times until another talkgroup is selected.

Further, in alternative embodiments, the PTT-button area 96 within the GUI 94 may be configured differently than as shown in FIG. 8. FIG. 9 illustrates one alternative implementation of the PTT-button area 96.

Namely, as shown in FIG. 9, numerical indicators (i.e., touchgroup indicators 100 in FIG. 8) positioned along the circumference of the circular area corresponding to the PTT-button area 96 may, instead, be replaced by indicators 104 that are not associated with any particular talkgroups. Such a configuration may allow an increased number of selectable talkgroups if, for example, it is not possible to fit all of the talkgroups available for selection around the perimeter of the PTT-button area 96. As the PTT-button area 96 receives an input (e.g., a touch input) causing the display device to display a rotation of the PTT-button area 96, indications of different selectable talkgroups may be displayed in the talkgroup-select area 98. The PTT-button area 96 may be “rotated” until an indication of a desired talkgroup is displayed in the talkgroup-select area 98. The selection of that talkgroup and initiation of a PTT communication with the talkgroup may occur in similar manners as described hereinbefore.

Various functions described hereinbefore in connection with FIGS. 8 and 9 may be implemented in software, such as by suitable program instructions stored in memory (e.g., a non-transitory computer readable medium) and executable by one or more processors. In this regard, the processor(s) may be programmed with suitable program instructions to generate the GUI 94, cause a display of rotation of the PTT-button area 96 (e.g., in response to the PTT button area 96 receiving a touch input performed in a rotational manner, as described hereinbefore)), and generate appropriate control signals to cause talkgroup selection and PTT communication initiation.

For instance, the processor(s) may be programmed to produce (i) a first control signal in response to the PTT-button area 96 receiving a first input to cause a selection of a talkgroup, and (ii) a second control signal in response to the PTT-button area 96 receiving a second input to cause an initiation of a PTT communication with the talkgroup. Further, the processor(s) may be programmed to measure a duration of the second input and generate suitable control signal(s) to cause either a PTT call alert or a PTT call to be initiated. In this regard, the display device including the PTT-button area 96 may be configured with suitable software/hardware to detect when the PTT-button area 96 is receiving the second input and provide an indication thereof (e.g., a suitable signal) to the processor(s).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A communication device having a push-to-talk (PTT) capability, the communication device comprising:
an interface configured to select a talkgroup and initiate a PTT communication with the talkgroup, wherein the interface includes a component configured to
(1) select the talkgroup in response to the component receiving a first input that causes a rotation of the component, and
(2) initiate the PTT communication with the talkgroup in response to the component receiving a second input that is different from the first input.

2. The communication device of claim 1, wherein the PTT communication is a PTT call alert or a PTT call.

3. The communication device of claim 2, wherein:
the component is configured to initiate the PTT call alert when a duration of the second input is less than a predetermined period of time, and
the component is configured to initiate the PTT call when the duration of the second input is at least the predetermined period of time.

4. The communication device of claim 1, wherein the interface comprises a physical PTT button.

5. The communication device of claim 4, wherein the communication device is a Land Mobile Radio (LMR) device.

6. The communication device of claim 1, wherein the communication device is configured to operate as a two-way radio and a mobile telephone.

7. The communication device of claim 1, wherein the interface comprises an apparatus including:
(i) a display device having a display area, and
(ii) a processor coupled with the display device and configured to execute program instructions to cause the display device to provide a graphical user interface (GUI) including a PTT-button area within the display area.

8. A physical push-to-talk (PTT) button for a communication device, the physical PTT button comprising:
a component that is rotatable and pressable, and configured to
(1) select a talkgroup responsive to the component being rotated, and
(2) initiate a PTT communication with the talkgroup responsive to the component being pressed.

9. The physical PTT button of claim 8, wherein the PTT communication is a PTT call alert or a PTT call.

10. The physical PTT button of claim 8, wherein:
the component includes a first portion and a second portion,
the first portion is rotatable about a first axis, and
the second portion is pressable along a second axis.

11. The physical PTT button of claim 10, wherein the first portion includes a rotary element operable with a finger.

12. The physical PTT button of claim 8, wherein the component includes a rotary encoder.

13. The physical PTT button of claim 8, wherein at least a portion of the component is located on a side of the communication device and rotates about an axis parallel to the side of the communication device.

14. The physical PTT button of claim 8, wherein:
the talkgroup is a first talkgroup out of a plurality of talkgroups available for selection, and
the component is configured to select (i) the first talkgroup when the component rotates to a first position and (ii) the second talkgroup when the component rotates to a second position different from the first position.

15. An apparatus comprising:
a display device having a display area; and
a processor coupled with the display device and configured to execute program instructions to cause the display device to provide a graphical user interface (GUI) including:
a PTT-button area occupying a portion of the display area, wherein:
(1) the PTT-button area is configured to select a talkgroup in response to the PTT-button area receiving a first input, the display device being configured to display a rotation of the PTT-button area in response to the PTT-button area receiving the first input, and
(2) the PTT-button area is configured to initiate a PTT communication with the talkgroup in response to the PTT-button area receiving a second input that is different from the first input.

16. The apparatus of claim 15, wherein the PTT communication is a PTT call alert or a PTT call.

17. The apparatus of claim 15, wherein the display device includes a touchscreen via which the PTT-button area receives the first input and the second input.

18. The apparatus of claim 17, wherein:
the first input is a first touch input, and
the second input is a second touch input different from the first touch input.

19. The apparatus of claim 15, wherein:
the PTT-button area is a circular area, and
the display device is configured to display the rotation of the circular area about an axis perpendicular to a physical display surface that covers the display area.

20. The apparatus of claim 15, wherein:
the talkgroup is a first talkgroup out of a plurality of talkgroups available for selection, and
the PTT-button area is configured to (i) select the first talkgroup in response to the PTT-button area receiving the first input, and (ii) to maintain the selection of the first talkgroup until the PTT-button area receives another first input to select a second talkgroup out of the plurality of talkgroups.
